(19) United States
(12) Patent Application Publication
(10) Pub. No.: US 2021/0108364 A1
(43) Pub. Date: Apr. 15, 2021

(54) TEXTILE PRODUCT HAVING APPLIED THEREON WITH A TREATING COMPOSITION

(71) Applicant: Rajiv Rai SACHDEV, New Delhi (IN)

(72) Inventor: Rajiv Rai SACHDEV, New Delhi (IN)

(21) Appl. No.: 17/044,775

(22) PCT Filed: Apr. 12, 2018
(86) PCT No.: PCT/IB2018/052556

§ 371 Date: Oct. 1, 2020

(30) Foreign Application Priority Data
Apr. 2, 2018 (IN) 201811012467

(51) Int. Cl. D06M 16/00; A01N 65/06; D06M 13/00; D06P 1/34

(52) U.S. Cl. CPC D06M 16/00; D06P 1/34; D06M 13/005; A01N 65/06

(57) ABSTRACT

The present description discloses a Textile Product having applied thereon with a treating composition, said composition comprising an extract of a pine needle in a concentration of 1% to 8% by weight of the Textile Product; wherein the said Textile Product has anti-microbial, anti-odor, anti-fungal, anti-oxidant, insect repellent, aromatic and an additive binding properties, and optionally an additive. The additive is selected from a group comprising of a herbal extract having insect & moth repellent properties; a herbal extract having medicinal properties; a piezoelectric effect mineral powder; a natural aroma and fragrance; natural dye, synthetic/chemical dye.

### FIELD OF THE INVETNION

The present disclosure in general relates to a Textile Product having applied thereon with a treating composition comprising an extract of a pine needle and the process to manufacture the said textile product.

### BACKGROUND TO THE INVENTION

The trees or shrubs from Pinaceae family are called as conifers. These are known for its commercial importance. The examples are cedars, firs, hemlocks, larches, pines and spruces.

Deodar/Devdar is known as Himalayan Cedar tree. It is a tall coniferous tree grown in Himalaya. The wood of tree contains aromatic essential oil which is very useful and have medicinal properties. Deodar is considered as tree of Gods and worshipped. The wood of tree is used for treatment of inflammations and rheumatoid arthritis. Pine oil is an essential oil obtained by the steam distillation of stumps, needles, twigs and cones from a variety of species of pine. Pine oil is a disinfectant that is mildly antiseptic. The inner wood is aromatic and used to make incense. Inner wood is distilled into essential oil. As insects avoid this tree, the essential oil is used as insect repellent on the feet of horses, cattle and camels. It also has antifungal properties and has some potential for control of fungal deterioration of spices during storage. The outer bark and stem are astringent.

Because of its antibacterial, antifungal and insect repellent properties, rooms made of deodar cedar wood are used to store meat and food grains like oats and wheat in Shimla, Kullu, and Kinnaur district of Himachal Pradesh.

Cedar oil is often used for its aromatic properties, especially in aromatherapy. It has a characteristic woody odour which may change somewhat in the course of drying out. The crude oils are often yellowish or darker in color. Its applications cover soap perfumes, household sprays, floor polishes and insecticides and is also used in microscope work as a clearing oil.

Pine needle, which is a pine leaf of trees of Pinaceae family, produces waste in huge amount. These pine needles can cause lot of damage to the environment if not removed. These are highly inflammable in nature and often become the cause for forest fires. Pine tree trunk is heat resistant hence in case of a forest fire pine trees survive the fire. But forest fire destroys the growth of other plant species whose produce provide sustenance to villagers and thus also disturb the ecological balance of the region. Additionally, dry pine foliage stops water from being absorbed by the soil and thus causes the depletion of ground water table. Furthermore, fallen dry pine foliage acts like a carpet on the forest floor and blocks the sunshine reaching ground and thereby stops the growth of grass which the cattle feed upon. There is a need for productive use of pine needle. Pine needles are being used in making of incense sticks.

Ever since man developed the art of weaving and knitting, the use of textile in the garments and clothing industry has remained on the forefront. While in the early days, textile was only made of fibres derived from natural sources, currently both natural as well as synthetic fibres are being used in making textile material. Regardless of the material used in making textile, treatment of the textile material as per the requirement has its own importance and has evolved significantly over time. There are many compounds known to be used in the treatment of textile which have binding properties but could not be retained on textiles for longer time. Pine needles have very good binding property but are not known to be used in textile industry.

Therefore, there is a need for use of pine needle in textile industry because of its binding property which is inexpensive and which could be retained on textiles for a much longer time.

### SUMMARY OF THE INVENTION

Thus there exists a need for process which mitigates at least some of the disadvantages of the state of the art.

This summary is provided to introduce a selection of concepts in a simple manner that is further described in the detailed description of the disclosure. This summary is not intended to identify key or essential inventive concepts of the subject matter nor is it intended for determining the scope of the disclosure.

The present description discloses a Textile Product having applied thereon with a treating composition, said composition comprising an extract of a pine needle in a concentration of 1% to 8% by weight of the Textile Product; wherein the said Textile Product has anti-microbial, anti-odour, anti-fungal, anti-oxidant, mosquito repellent, aromatic and additive binding properties, and optionally an additive.

In an embodiment of the present invention, the additive is selected from a group comprising of a herbal extract having insect & moth-repellent properties, a herbal extract having medicinal properties, a piezoelectric effect mineral powder, a natural aroma and fragrance, natural dye, synthetic/chemical dye.

In preferred embodiments, the herbal extract having insect & moth repellent properties is selected from a group comprising of Eucalyptus extract, Lavender extract, Melissa extract, Rosemary extract, Lemon Grass extract, Basil extract, Pelargonium citrosum extract, Mentha piperita extract, Zanthoxylum limonella extract, Blumea lacera extract and combination thereof;
(i) the herbal extract having medicinal properties is selected from a group comprising of Neem (Azadirachta indica extract, Holy Basil (Ocimum tenuiflorum)extract and combination thereof;
(ii) the piezoelectric effect mineral powder is selected from a group comprising of Tourmaline, Quartz and Topaz and combination thereof;
(iii) the aroma and fragrance are selected from a group comprising of rose, lavender, chameli, jasmine, musk, lemon and combination thereof;
(iv) the natural dye is obtained from one or more of the root, stem, bark, leaf, fruit, fruit rind or flower of at least one of Acacia catechu, Acacia nilotica, Mallotus philippensis, Petro carpus santanils, Punica garantum, Quercu infrctoria, Rheurnemodi, Rubia cardifolia, Rumex maritmus, Terminalia chebula Indigoferra tinctoria and like.
(v) Synthetic dyes are manmade and are made from chemicals such as petroleum and sometimes in combination with mineral-derived components.

To further clarify advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1 is a flow chart of an exemplary process alongside Natural Dyes, in accordance with aspects of the present technique;

FIG. 2 is a flow chart of an exemplary process using only Pine Needles and Eucalyptus, in accordance with aspects of the present technique;

FIG. 3 is a flow chart of an exemplary process using Herbal dyes and Pine needle extract, in accordance with aspects of the present technique;

FIG. 4 is a flow chart of an exemplary process using Chemical/Synthetic dyes, in accordance with aspects of the present technique;

FIG. 5 is a flow chart of an exemplary process using Chemical/Synthetic dyes, in accordance with aspects of the present technique.

### DETAILED DESCRIPTION OF THE INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The methods, and examples provided herein are illustrative only and not intended to be limiting.

Embodiments of the present disclosure will be described below in detail with reference to the accompanying figures.

The present invention discloses a textile product having applied thereon a treating composition, said composition comprising an extract of a pine needle in a concentration of 1% to 8% by weight of the Textile Product. The said treated Textile Product has anti-microbial, anti-odour, anti-fungal, anti-oxidant, mosquito repellent and additive binding properties, and optionally an additives. The present invention shows good durability and longevity of the textile product with mentioned properties.

In an embodiment of the present invention, the additive is selected from a group comprising of a herbal extract having insect & moth repellent properties; a herbal extract having medicinal properties; a piezoelectric effect mineral powder; a natural aroma and fragrance; natural dye, synthetic/chemical dye. The herbal extract having insect & moth repellent properties is selected from a group comprising of Eucalyptus extract, Lavender extract, Melissa extract, Rosemary extract, Lemon Grass extract, Basil extract, Pelargonium citrosum extract, Mentha piperita extract, Zanthoxylum limonella extract, Blumea lacera extract and combination thereof. Apart from these any herbal extracts with insect repellent or insecticidal properties can be used. The herbal extract having medicinal properties is selected from a group comprising of Neem (Azadirachta indica) extract, Holy Basil (Ocimum tenuiflorum) extract and combination thereof. Apart from these any herbal extracts with required medicinal properties can be used. The piezoelectric effect mineral powder is selected from a group comprising of Tourmaline, Quartz and Topaz and combination thereof. The aroma and fragrance are selected from a group comprising of rose, lavender, chameli, jasmine, musk, lemon and combination thereof. Apart from these any aromatic herbs with required fragrance can be used. The natural dye is obtained from one or more of the root, stem, bark, leaf, fruit, fruit rind or flower of at least one of Acacia catechu, Acacia nilotica, Mallotus philippensis, Petro carpus santanils, Punica garantum, Quercu infrctoria, Rheurnemodi, Rubia cardifolia, Rumex maritmus, Terminalia chebula or Indigoferra tinctoria. Apart from these any resource of natural dyes can be used.

In another embodiments of the present invention, said Textile is derived from any kind of Natural Textile or Manmade/Synthetic Textile, wherein: Natural Textile is selected from a group comprising of Organic Cotton, Cotton, Silk, Wool, Linen, Hemp, Bamboo, Coconut palm, Soya and combination thereof; and Manmade/Synthetic fibre is selected from a group comprising of Nylon, Polyester, Acrylic, Lyocell, Modal, Micro Modal, Micro Modal Air, Rayon, Spandex and combination thereof. Apart from these any resource of Textiles can be used.

Another embodiment of the present invention discloses a process for preparing a Textile Product, comprising: treating a Textile with a treating composition to obtain the Textile Product, said composition comprising extract of pine needle in a concentration of 1% to 8% by weight of the Textile Product. The said Textile Product has anti-microbial, anti-odour, anti-fungal, anti-oxidant, Insect & Moth repellent, aromatic and additive binding properties.

An additive can optionally be added to the Textile Product. The process for preparing a Textile Product comprises the following steps:
(i) treating the textile in a dye bath having Material Liquor Ratio in the range of 1:5 to 1:20 of the weight of the Textile Product with the extract of pine needle in the concentration of 1% to 8% of the weight of the Textile Product, maintaining pH in a range of 7.5 to 9 using Soda Ash, at a temperature in a range of 50° C. to 100° C. to obtain a treated textile product,
(ii) optionally, adding the additive to the treated Textile Product;
(iii) washing the treated textile product with a non-ionic soap at a soaping temperature of 40° C. to 80° C. to obtain a washed textile product;
(iv) adjusting pH of the washed textile product using Malic Acid for Acidic pH in the range of 5 to 6.5 ideally suited to a human body; and
(v) adding alum in the range of 0.5 to 3 wt. % o.w.t. (of the weight of textile product) to the dye bath containing the washed textile product to obtain the Textile Product.

The additive used in process for preparing the Textile Product is selected from a group comprising of a herbal extract having insect & moth repellent properties, a herbal extract having medicinal properties, a piezoelectric effect mineral powder, a natural aroma and fragrance, natural dye, synthetic/chemical dye:
(i) the herbal extract having insect & moth repellent properties is selected from a group comprising of Eucalyptus extract, Lavender extract, Melissa extract, Rosemary extract, Lemon Grass extract, Basil extract, Pelargonium citrosum extract, Mentha piperita extract, Zanthoxylum limonella extract, Blumea lacera extract and combination thereof;
(ii) the herbal extract having medicinal properties is selected from a group comprising of Neem (Azadirachta indica) extract, Holy Basil (Ocimum tenuiflorum) extract and combination thereof;
(iii) the piezoelectric effect mineral powder is selected from a group comprising of Tourmaline, Quartz and Topaz and combination thereof;
(iv) the aromas and fragrances are selected from a group comprising of rose, lavender, chameli, jasmine, musk, lemon and combination thereof;
(v) the natural dye is obtained from one or more of root, stem, bark, leaf, fruit, fruit rind or flower of at least one of Acacia catechu, Acacia nilotica, Mallotus philippensis, Petro carpus santanils, Punica garantum, Quercu infrctoria, Rheurnemodi, Rubia cardifolia, Rumex maritmus, Terminalia chebula or Indigoferra tinctoria.

The Textile is derived from any kind of Natural Textile or Manmade/Synthetic Textile, wherein the Natural Textile is selected from a group comprising of Organic Cotton, Cotton, Silk, Wool, Linen, Hemp, Bamboo, Coconut palm, Soya and combination thereof; and Manmade/Synthetic fibre is selected from a group comprising of Nylon, Polyester, Acrylic, Lyocell, Modal, Micro Modal, Micro Modal Air, Rayon, Spandex and combination thereof.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

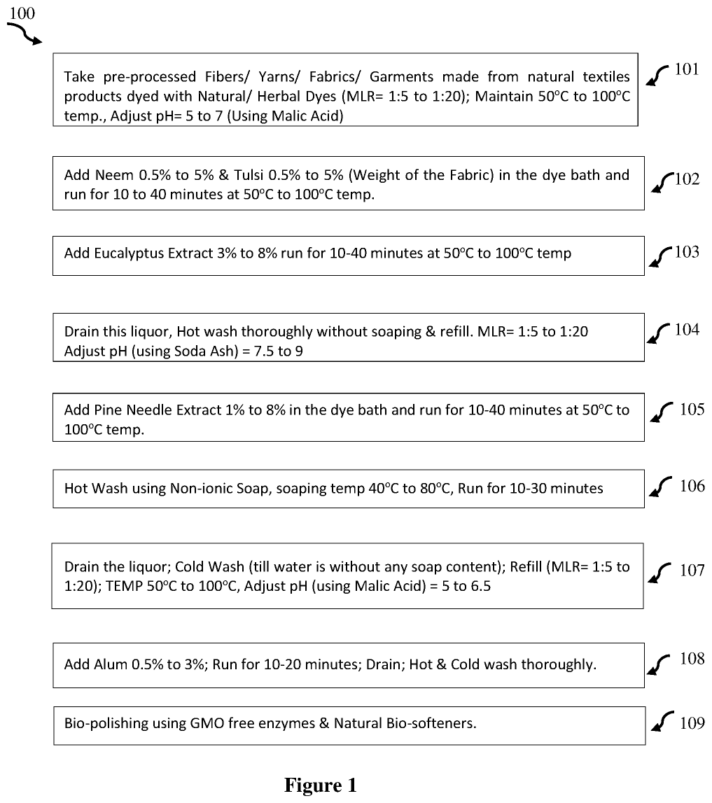

FIG. 1 is a flow chart showing various steps involved in the method of treating a textile dyed with natural or herbal dye (100). With respect to FIG. 1 a pre-processed textile dyed with natural or herbal dye, has been taken. The pre-processed textile has been selected from the group consisting of fibers, yarns, fabrics, garments made from natural textile products and dyed with natural or herbal dye (101). The Material Liquor Ration (MLR ratio) of the liquor may be maintained from 1:5 to 1:20. The pH of the solution has been maintained in a range of 5 to 7 using malic acid at a temperature of about 50° C. to 100° C. A herbal extract, such as of Neem and Holy Basil each with concentrations in a range of 0.5% to 5.0% by weight of the textile product, is used to treat the textile product for a period in the range of 10-40 minutes at a temperature of 50° C. to 100° C. (102). The textile material is then treated with Eucalyptus extract used in the range of 3% to 8% for 10-40 minutes at a temperature of 50° C. to 100° C. (103). After the textile material is treated in step 103, the liquor is drained, hot washed thoroughly without soap and refilled again with liquor having MLR maintained from 1:5 to 1:20 in step 104. The pH is maintained from 7.5 to 9.0 using Soda Ash. The textile material then treated with Pine needle extract used in the range of 1% to 8% for 10-40 minutes at a temperature of 50° C. to 100° C. (105). The textile product obtained after stage 105 is subjected to hot wash for about 10-30 minutes using non-ionic soap solution at a temperature in the range of 40° C. to 80° C. at step 106. Once the textile product is hot washed using soap solution, the liquor is drained and the textile product is subjected to cold wash and refilled again with liquor having MLR maintained from 1:5 to 1:20 in step 107. The temperature is maintained in the range of 50° C. to 100° C. The pH may be maintained to 5.0 to 6.5 using Malic acid. The textile is then treated with Alum (0.5% to 3.0%) for 10-20 minutes in step 108. The textile product obtained after stages 108 is subjected to hot wash and cold wash. Thereafter, in step 109, bio-polishing using bio-enzymes is performed on the washed textile product. After bio-polishing, the liquor is drained and refilled again. The textile product is then softened with any known suitable GOTS approved softener. This step helps the textile product to become soft enough for optimal feel.

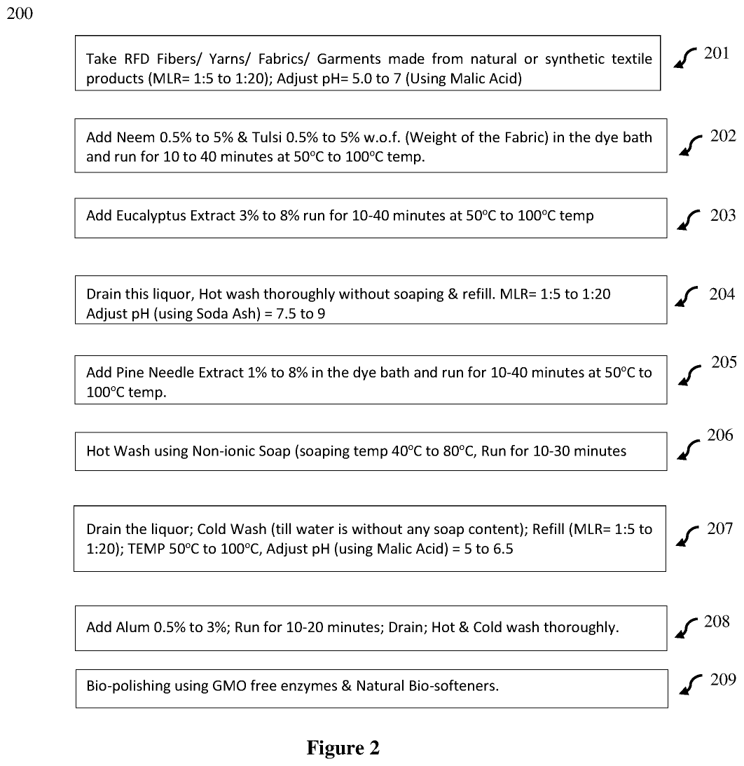

FIG. 2 describes the process (200) where the RFD (Ready for Dyeing) textile products have been used. The RFD textile has been selected from the group consisting of fibers, yarns, fabrics, garments made from natural or synthetic textile products (201). The Material Liquor Ration (MLR ratio) of the liquor has been maintained in the range of 1:5 to 1:20. The pH of the solution has been maintained in the range of 5 to 7 using malic acid. A herbal extract, such as of Neem and Holy Basil each with concentrations in the range of 0.5% to 5.0% by weight of the textile product, is used to treat the textile product for a period of 10 to 40 minutes at a temperature of 50° C. to 100° C. (202). Textile material is then treated with Eucalyptus extract used in the range of 3% to 8% for a period of 10-40 minutes at a temperature of 50° C. to 100° C. (203). After the textile material is treated in step 203, the liquor is drained, hot washed thoroughly without soap and refilled again with liquor having MLR maintained in a range of 1:5 to 1:20 in step 204. The pH is maintained in a range of 7.5 to 9.0 using Soda Ash. Textile material is then treated with Pine needle extract used in the range of 1% to 8% for a period of 10-40 minutes at a temperature of 50° C. to 100° C. (205). The textile product obtained after stage 205 is subjected to hot wash for a period in the range of 10-30 minutes using non-ionic soap solution at a temperature in the range of 40° C. to 80° C. in step 206. Once the textile product is hot washed using soap solution, the liquor is drained and the textile product is subjected to cold wash and refilled again with liquor having MLR maintained in a range of 1:5 to 1:20 in step 207. The temperature is maintained in the range of 50° C. to 100° C. and the pH is maintained in a range of 5.0 to 6.5 using Malic acid. The textile is then treated with Alum used in the range of 0.5% to 3.0% for a period in the range of 10-20 minutes in step 208. The textile product obtained after stages 208 is subjected to hot and cold wash. Thereafter, at step 209, bio-polishing using bio-enzymes is performed on the washed textile product. After bio-polishing, the liquor is drained and refilled again. The textile product is then softened with known suitable GOTS approved softener in step 209. This step helps the textile product to become soft enough for optimal feel.

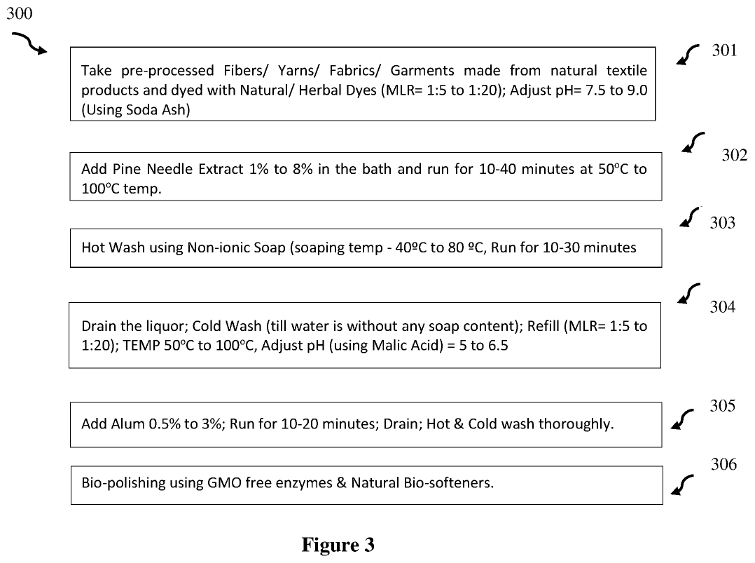

FIG. 3 describes the process (300) where the pre-processed textile dyed with natural or herbal dye, has been used. The pre-processed textile has been selected from the group consisting of fibers, yarns, fabrics, garments made from natural textile products and dyed with natural or herbal dye (301). The Material Liquor Ratio (MLR ratio) of the liquor is maintained in the range of 1:5 to 1:20. The pH of the solution has been maintained in the range of 7.5 to 9 using Soda Ash. Textile material is then treated with Pine needle extract used in the range of 1% to 8% for a period in the range of 10 to 40 minutes at a temperature of 50° C. to 100° C. (302). The textile product obtained after stage 302 is subjected to hot wash for a period in the range of 10 to 30 minutes using non-ionic soap solution at a temperature in the range of 40° C. to 80° C. in step 303. Once the textile product is hot washed using soap solution, the liquor is drained and the textile product is subjected to cold wash and refilled again with liquor having MLR maintained in the range of 1:5 to 1:20 in step 304. Temperature is maintained in the range of 50° C. to 100° C. The pH is maintained in a range of 5.0 to 6.5 using Malic acid. The textile is then treated with Alum used in the range of 0.5% to 3.0% for a period in the range of 10 to 20 minutes in step 305. The textile product obtained after stages 305 is subjected to hot and cold wash. Thereafter, in step 306, bio-polishing using bio-enzymes is performed on the washed textile product. After bio-polishing, the liquor is drained and refilled again. The textile product is then softened with known suitable GOTS approved softener in step 306. This step helps the textile product to become soft enough for optimal feel.

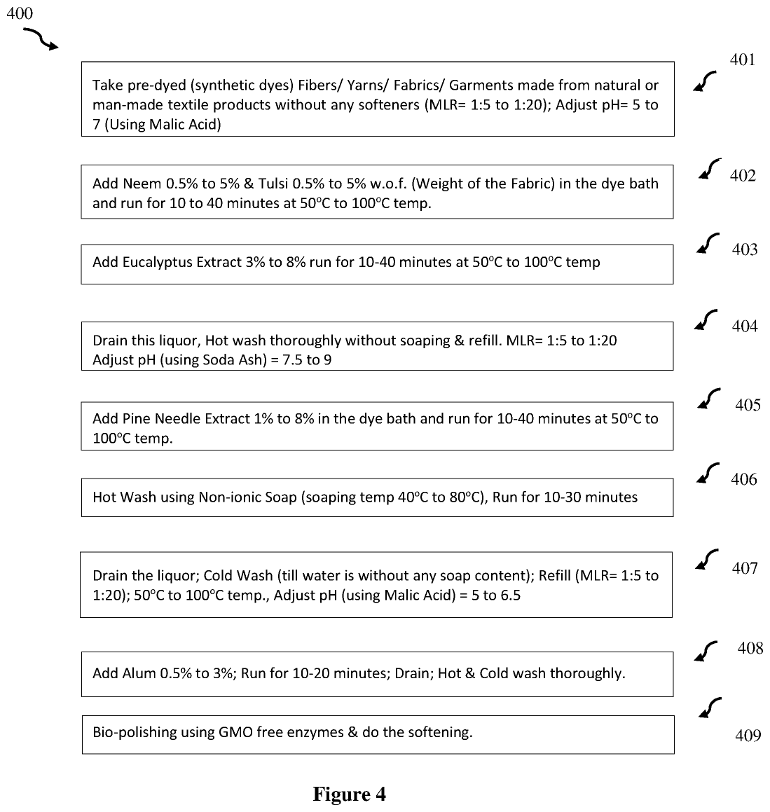

FIG. 4 describes the process (400) where the pre-processed textile products dyed with synthetic dyes without any softeners, has been used. The pre-processed textile has been selected from the group consisting of fibers, yarns, fabrics, garments made from natural or and man-made textiles products (401).The Material Liquor Ration (MLR ratio) of the liquor is maintained in the range of 1:5 to 1:20. The pH of the solution has been maintained in the range of 5 to 7 using malic acid. A herbal extract, such as of Neem and Holy Basil each with concentrations in the range of 0.5% to 5.0% by weight of the textile product, is used to treat the textile product for a period in the range of 10 to 40 minutes at a temperature in the range of 50° C. to 100° C. (402). Textile material is then treated with Eucalyptus extract used in the range of 3% to 8% for a period in the range of 10 to 40 minutes at a temperature in the range of 50° C. to 100° C. (403). After the textile material is treated in step 403, the liquor is drained, hot washed thoroughly without soap and refilled again with liquor having MLR maintained in the range of 1:5 to 1:20 in step 404. The pH is maintained in the range of 7.5 to 9.0 using Soda Ash. Textile material is then treated with Pine needle extract used in the range of 1% to 8% for a period in the range of 10 to 40 minutes at a temperature in the range of 50° C. to 100° C. (405). The textile product obtained after stage 405 is subjected to hot wash for a period in the range of 10 to 30 minutes using non-ionic soap solution at a temperature in the range of 40° C. to 80° C. in step 406. Once the textile product is hot washed using soap solution, the liquor is drained and the textile product is subjected to cold wash and refilled again with liquor having MLR maintained in the range of 1:5 to 1:20 in step 407. The temperature is maintained in the range of 50° C. to 100° C. The pH is maintained in the range of 5.0 to 6.5 using Malic acid. The textile is then treated with Alum used in the range of 0.5% to 3.0% for a period in the range of 10 to 20 minutes in step 408. The textile product obtained after stages 408 is subjected to hot and cold wash. Thereafter, in step 409, bio-polishing using bio-enzymes is performed on the washed textile product. After bio-polishing, the liquor is drained and refilled again. The textile product is then softened with known suitable GOTS approved softener. This step helps the textile product to become soft enough for optimal feel.

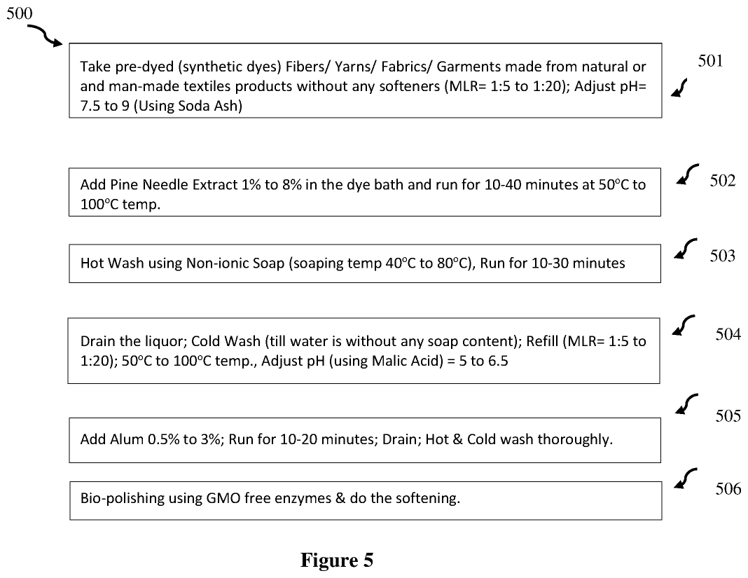

FIG. 5 describes the process (500) where the pre-processed textile products dyed with synthetic dyes without any softeners, has been used. The pre-processed textile has been selected from the group consisting of fibers, yarns, fabrics, garments made from natural or and man-made textiles products (501).The Material Liquor Ration

(MLR ratio) of the liquor is maintained in the range of 1:5 to 1:20. The pH of the solution has been maintained in the range of 7.5 to 9.0 using Soda Ash. Textile material is then treated with Pine needle extract used in the range of 1% to 8% for a period in the range of 10 to 40 minutes at a temperature in the range of 50° C. to 100° C. (502). The textile product obtained after stage 502 is subjected to hot wash for a period in the range of 10 to 30 minutes using non-ionic soap solution at a temperature in the range of 40° C. to 80° C. in step 503. Once the textile product is hot washed using soap solution, the liquor is drained and the textile product is subjected to cold wash and refilled again with liquor having MLR maintained in the range of 1:5 to 1:20. The temperature is maintained in the range of 50° C. to 100° C. in step 504. The pH is maintained in the range of 5.0 to 6.5 using Malic acid. The textile is then treated with Alum used in the range of 0.5% to 3.0% for a period of 10 to 20 minutes in step 505. The textile product obtained after stage 505 is subjected to hot and cold wash. Thereafter, at step 506, bio-polishing using bio-enzymes is performed on the washed textile product. After bio-polishing, the liquor is drained, cold washed and refilled again. The textile product is then softened with known suitable GOTS approved softener in step 506. This step helps the textile product to become soft enough for optimal feel.

I claim:

1. A Textile Product having applied thereon a treating composition, said composition comprising an extract of pine needle in a concentration of 1% to 8% by weight of the Textile Product; wherein the said Textile Product has anti-microbial, anti-odour, anti-fungal, anti-oxidant, insect repellent, aromatic and additive binding properties, and optionally an additive.

2. The Textile Product as claimed in claim 1, wherein the additive is selected from a group comprising of a herbal extract having insect repellent properties, a herbal extract having medicinal properties, a piezoelectric effect mineral powder, a natural aroma and fragrance, natural dyes, synthetic/chemical dyes, wherein:
(i) the herbal extracts having insect-repellent properties is selected from a group comprising of Eucalyptus extract, Lavender extract, Melissa extract, Rosemary extract, Lemon Grass extract, Basil extract, Pelargonium citrosum extract, Mentha piperita extract, Zanthoxylum limonella extract, Blumea lacera extract and combination thereof;
(ii) the herbal extract having medicinal properties is selected from a group comprising of Neem (Azadirachta indica) extract, Holy Basil (Ocimum tenuiflorum)extract and combination thereof;
(iii) the piezoelectric effect mineral powder is selected from a group comprising of Tourmaline, Quartz and Topaz and combination thereof;
(iv) the aroma and fragrance are selected from a group comprising of rose, lavender, chameli, jasmine, musk, lemon and combination thereof;
(v) the natural dye is obtained from one or more of the root, stem, bark, leaf, fruit, fruit rind or flower of at least one of Acacia catechu, Acacia nilotica, Mallotus philippensis, Petro carpus santanils, Punica garantum, Quercu infrctoria, Rheurnemodi, Rubia cardifolia, Rumex maritmus, Terminalia chebula or Indigoferra tinctoria.

3. The Textile Product as claimed in claim 1, wherein said Textile is derived from Natural Textile or Manmade textile or Synthetic Textile, wherein:
Natural Textile product is selected from a group comprising of Organic Cotton, Cotton, Silk, Wool, Linen, Hemp, Bamboo, Coconut palm, Soya and combination thereof; and
Manmade textile product/Synthetic textile product are selected from a group comprising of Nylon, Polyester, Acrylic, Lyocell, Modal, Micro Modal, Micro Modal Air, Rayon, Spandex and combination thereof.

4. A process for preparing a Textile Product, comprising:
(i) treating a Textile with a treating composition to obtain the Textile Product, said composition comprising extract of pine needle in a concentration of 1% to 8% by weight of the Textile Product;
wherein said Textile Product has anti-microbial, anti-odour, anti-fungal, anti-oxidant, insect repellent, aromatic and additive binding properties,
(ii) optionally, adding an additive to the Textile Product.

5. The process as claimed in claim 4, wherein the process comprises:
(i) treating the textile in a dye bath having Material Liquor Ratio in a range of 1:5 to 1:20 of the weight of the Textile Product with the extract of pine needle in the concentration of 1% to 8% of the weight of the Textile Product, maintaining pH in a range of 7.5 to 9 using Soda Ash, at a temperature in a range of 50° C. to 100° C. to obtain a treated textile product,
(ii) optionally, adding the additive to the treated Textile Product;
(iii) washing the treated textile product with a non-ionic soap at a soaping temperature of 40° C. to 80° C. to obtain a washed textile product;
(iv) adjusting pH of the washed textile product using Malic Acid for Acidic pH in the range of 5 to 6.5 ideally suited to a human body, temp. 50° C. to 100° C.; and
(v) adding alum in the range of 0.5 to 3% o.w.t. (of the weight of textile product) to the dye bath containing the washed textile product to obtain the Textile Product.

6. The process as claimed in claim 4, wherein the additive is selected from a group comprising of a herbal extract having insect repellent properties, a herbal extract having medicinal properties, a piezoelectric effect mineral powder, a natural aroma and fragrance, natural dyes, synthetic/chemical dyes, wherein:
(i) the herbal extract having insect repellent properties is selected from a group comprising of Eucalyptus extract, Lavender extract, Melissa extract, Rosemary extract, Lemon Grass extract, Basil extract, Pelargonium citrosum extract, Mentha piperita extract, Zanthoxylum limonella extract, Blumea lacera extract and combination thereof;
(ii) the herbal extract having medicinal properties is selected from a group comprising of Neem (Azadirachta indica) extract, Holy Basil (Ocimum tenuiflorum) extract and combination thereof;
(iii) the piezoelectric effect mineral powder is selected from a group comprising of Tourmaline, Quartz and Topaz and combination thereof;
(iv) the aromas and fragrances are selected from a group comprising of rose, lavender, chameli, jasmine, musk, lemon and combination thereof;
(v) the natural dye is obtained from one or more of root, stem, bark, leaf, fruit, fruit rind or flower of at least one of Acacia catechu, Acacia nilotica, Mallotus philippensis, Petro carpus santanils, Punica garantum, Quercu infrctoria, Rheurnemodi, Rubia cardifolia, Rumex maritmus, Terminalia chebula or Indigoferra tinctoria.

7. The process as claimed in claim 4, wherein said Textile is derived from Natural Textile or Manmade textile or Synthetic Textile, wherein:
Natural Textile is selected from a group comprising of Organic Cotton, Cotton, Silk, Wool, Linen, Hemp, Bamboo, Coconut palm, Soya and combination thereof; and
Manmade textile product and Synthetic textile product are selected from a group comprising of Nylon, Polyester, Acrylic, Lyocell, Modal, Micro Modal, Micro Modal Air, Rayon, Spandex and combination thereof.
